(19) United States
(12) Patent Application Publication
(10) Pub. No.: US 2019/0184507 A1
(43) Pub. Date: Jun. 20, 2019

(54) CNC Single-Turret Twin-Spindle Efficiency-Doubled Metal Processing Machine

(71) Applicant: Baizheng Innovation Technology Co., Ltd., Taichung City (TW)

(72) Inventor: Feng-Tien Chen, Taichung City (TW)

(21) Appl. No.: 16/186,612

(22) Filed: Nov. 12, 2018

(30) Foreign Application Priority Data
Dec. 19, 2017 (TW) 106144610

(51) Int. Cl. B23Q 1/54; B23Q 1/01; G05B 19/18

(52) U.S. Cl. CPC B23Q 1/54; G05B 2219/45124; G05B 19/182; B23Q 1/01

(57) ABSTRACT

A CNC single-turret twin-spindle efficiency-doubled metal processing machine includes: a chassis having a Z-axis mounting surface and a Y-axis mounting surface perpendicular to the Z-axis mounting surface; a spindle driving source mounted on the Z-axis mounting surface of the chassis; a first spindle unit arranged on the Z-axis mounting surface of the chassis and coupled to the spindle driving source; a second spindle unit arranged on the Z-axis mounting surface of the chassis and coupled to the spindle driving source so that the spindle driving source is operable to simultaneously drive the first spindle unit and the second spindle unit to do reciprocal movement on the same axis for approaching and leaving; a turret unit mounted on the Y-axis mounting surface of the chassis and including a plurality of clamp groups arranged at predetermined angles. Each of the clamp groups includes two tool clamps that respectively clamp two identical tools.

### (a) TECHNICAL FIELD OF THE INVENTION

The present invention relates generally to a processing machine, and more particularly to a computer numerical control (CNC) single-turret twin-spindle efficiency-doubled metal processing machine.

### (b) DESCRIPTION OF THE PRIOR ART

A conventional processing machine comprises a spindle to which a work piece is attached and a tool carried by a turret to carry out a processing operation on the work piece.

The known processing machine suffers poor working efficiency and a general-purpose efficiency-doubled CNC turning machine has been proposed, such as Taiwan Utility Model M436521, in which an arrangement of two spindles and two turrets is disclosed so that the two spindles may each carry a workpiece and tools carried on the two turrets may simultaneously carry out processing operations on the two work pieces carried by the two spindles, whereby doubling of the working efficiency can be realized. However, such a processing machine is bulky in size because two turrets are included. In addition, the overall cost is significantly increased due to the increased number of turrets, making it poor in market competition.

### SUMMARY OF THE INVENTION

In view of the above, to overcome the drawbacks of the prior art double-efficiency processing machine that the size is bulky, the fabrication cost is high, and the market competition power is poor, the present invention provides a computer numerical control (CNC) single-turret twin-spindle efficiency-doubled metal processing machine, which generally comprises: a chassis, which comprises a Z-axis mounting surface and a Y-axis mounting surface that is perpendicular to the Z-axis mounting surface; a spindle driving source, which is mounted on the Z-axis mounting surface of the chassis; a first spindle unit, which is arranged on the Z-axis mounting surface of the chassis and is coupled to the spindle driving source; a second spindle unit, which is arranged on the Z-axis mounting surface of the chassis and is coupled to the spindle driving source so that the spindle driving source is operable to simultaneously drive the first spindle unit and the second spindle unit to do reciprocal movement on the same axis for approaching and leaving; a turret unit, which is mounted on the Y-axis mounting surface of the chassis, the turret unit being provided with a plurality of clamp groups arranged at predetermined angles respectively, the clamp group of each of the angles comprising two tool clamps, so that the two tool clamps respectively clamp two identical tools. since the present invention needs just one single turret unit to simultaneously carry out processing operations on two work pieces, it is possible to achieve an effect of doubling the processing efficiency, and it is also possible to greatly reduce the overall size and also reduce the fabrication cost thereby improving market competition power.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a first embodiment of the present invention.

FIG. 2 is a perspective view of the embodiment shown in FIG. 1 in an assembled form.

FIG. 3 is a partly exploded view of the embodiment of FIG. 1.

FIGS. 4-7 are schematic views illustrating an operation of the embodiment of FIG. 1.

FIG. 8 is a schematic view illustrating a condition of use of the embodiment of FIG. 1.

FIG. 9 is an exploded view showing a second embodiment of the present invention.

FIG. 10 is a perspective view of the embodiment shown in FIG. 9 in an assembled form.

FIG. 11 is a schematic view illustrating an operation of the embodiment of FIG. 9.

FIG. 12 is a schematic view illustrating a condition of use of the embodiment of FIG. 9.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

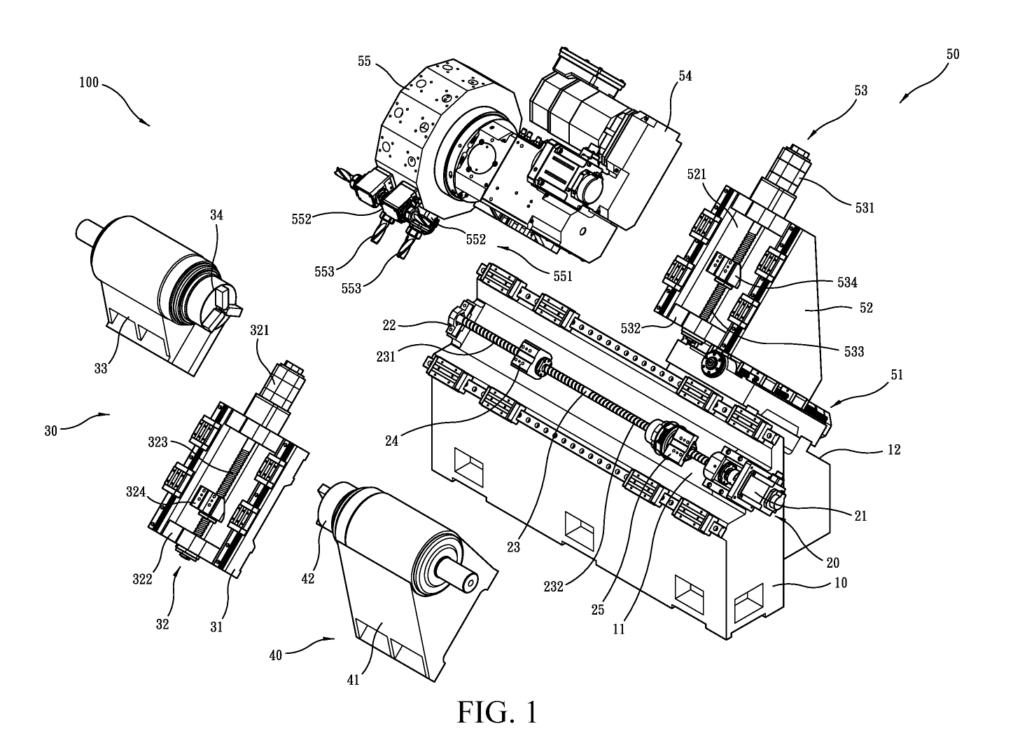

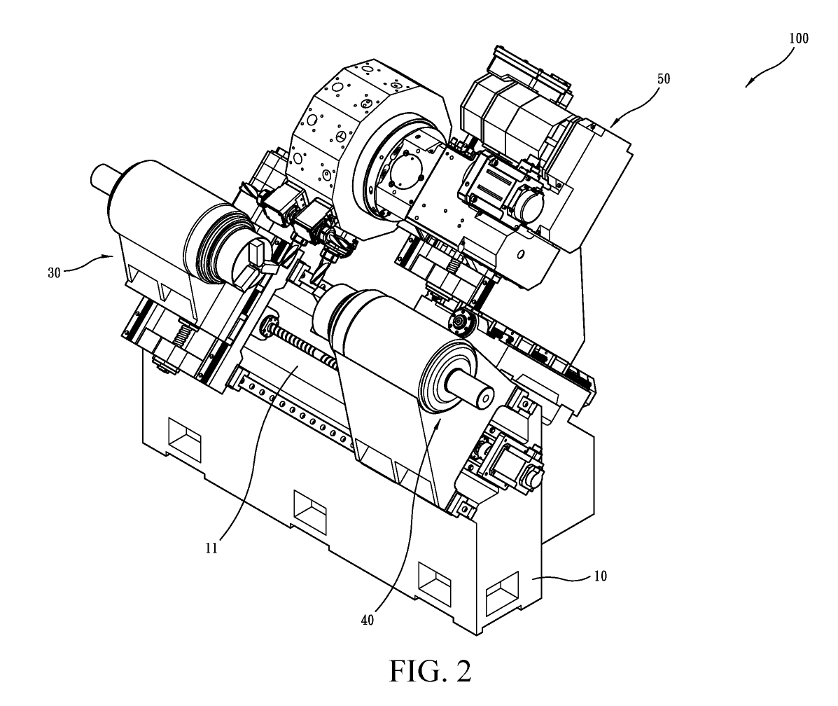

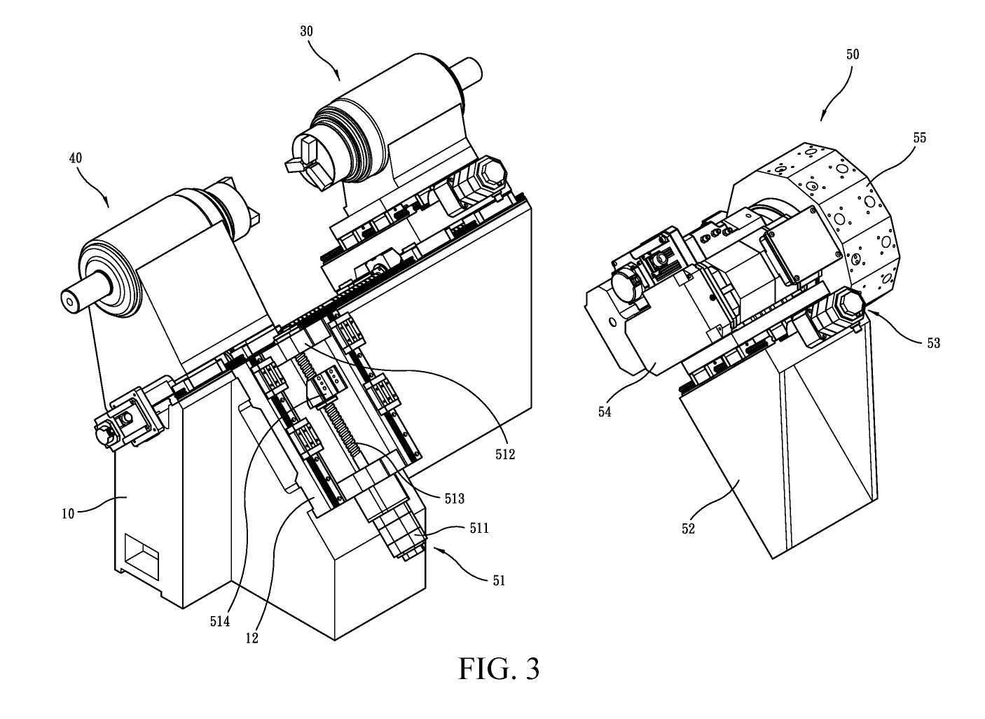

Referring to FIGS. 1-8, the present invention provides, as a first embodiment, a computer numerical control (CNC) single-turret twin-spindle efficiency-doubled metal processing machine 100, which generally comprises a chassis 10, a spindle driving source 20, a first spindle unit 30, a second spindle unit 40, and a turret unit 50.

Referring to FIGS. 1-3, the chassis 10 is securely positioned on a ground surface (or a planar fixture surface). The chassis 10 comprises a Z-axis mounting surface 11 and a Y-axis mounting surface 12 that is perpendicular to the Z-axis mounting surface 11.

Referring to FIGS. 1-3, the spindle driving source 20 is mounted on the Z-axis mounting surface 11 of the chassis 10. The spindle driving source 20 comprises a driving motor 21, a bearing seat 22, a screw rod 23, a first nut 24, and a second nut 25. The driving motor 21 is mounted on the Z-axis mounting surface 11 of the chassis 10, and the bearing seat 22 is mounted on the Z-axis mounting surface 11 of the chassis 10 at an opposite end portion thereof. The screw rod 23 has one end coupled to the driving motor 21 and an opposite end supported by the bearing seat 22, so the screw rod 23 is rotatable, in situ, on the Z-axis mounting surface 11. The screw rod 23 has an outer circumferential surface that comprises a forward (such as right-handed) thread section 231 and a backward (such as left-handed) thread section 232. The first nut 24 is in threading engagement with the forward thread section 231 of the screw rod 23, and the second nut 25 is in threading engagement with the backward thread section 232.

Referring to FIGS. 1-3, the first spindle unit 30 comprises a first compensation seat 31, a first compensation power source 32, a first spindle seat 33, and a first spindle 34. The first compensation seat 31 is securely fixed to the first nut 24 of the spindle driving source 20. The first compensation power source 32 is mounted on the first compensation seat 31. The first compensation power source 32 comprises a motor 321, a bearing seat 322, a screw rod 323, and a nut 324. The motor 321 is mounted on the first compensation seat 31, and the bearing seat 322 is mounted on an opposite end portion of the first compensation seat 31. The screw rod 323 has an end coupled to the motor 321 and an opposite end supported by the bearing seat 322. The nut 324 is in threading engagement with the screw rod 323. The first spindle seat 33 is securely fixed to the nut 324 of the first compensation power source 32. The first spindle 34 is mounted on the first spindle seat 33 to clamp a work piece to be processed.

Referring to FIGS. 1-3, the second spindle unit 40 comprises a second spindle seat 41 and a second spindle 42. The second spindle seat 41 is securely fixed to the second nut 25 of the spindle driving source 20. The second spindle 42 is mounted on the second spindle seat 41 to clamp a work piece to be processed.

Referring to FIGS. 1-3, the turret unit 50 comprises a Y-axis driving source 51, a Y-axis seat 52, an X-axis driving source 53, an X-axis seat 54, and a turret 55. The Y-axis driving source 51 is mounted on the Y-axis mounting surface 12 of the chassis 10. The Y-axis driving source 51 comprises a motor 511, a bearing seat 512, a screw rod 513, and a nut 514. The motor 511 is mounted on the Y-axis mounting surface 12. The bearing seat 512 is mounted on an opposite end portion of the Y-axis mounting surface 12. The screw rod 513 has an end coupled to the motor 511 and an opposite end supported by the bearing seat 512. The nut 514 is in threading engagement with the screw rod 513. The Y-axis seat 52 is securely fixed to the nut 514 of the Y-axis driving source 51. The Y-axis seat 52 comprises an X-axis mounting surface 521. The X-axis driving source 53 is mounted on the X-axis mounting surface 521 of the Y-axis seat 52. The X-axis driving source 53 comprises a motor 531, a bearing seat 532, a screw rod 533, and a nut 534. The motor 531 is mounted on the X-axis mounting surface 521. The bearing seat 532 is mounted on an opposite end portion of the X-axis mounting surface 521. The screw rod 533 has an end coupled to the motor 531 and an opposite end supported by the bearing seat 532. The nut 534 is in threading engagement with the screw rod 533. The X-axis seat 54 is securely fixed to the nut 534 of the X-axis driving source 53. The turret 55 is rotatably mounted to the X-axis seat 54. The turret 55 comprises a plurality of clamp groups 551 respectively arranged at predetermined angles thereof and the clamp group 551 of each of the angles comprises two tool clamps 552, so that the two tool clamps 552 may respectively clamp two identical tools 553.

The above provides a description to the components of the CNC single-turret twin-spindle efficiency-doubled metal processing machine 100 according to the first preferred embodiment of the present invention and the assembly thereof, and the following will provide a description to an operation thereof.

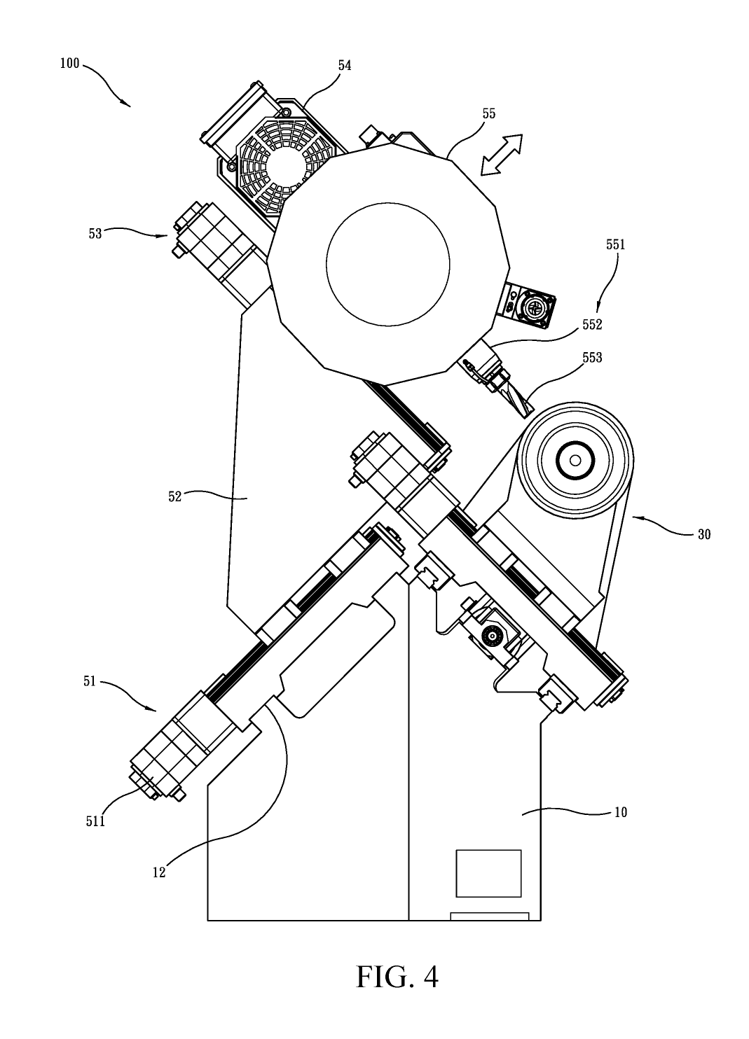

Firstly, as shown in FIG. 4, in the present invention, the turret unit 50 uses the motor 511 of the Y-axis driving source 51 to drive the screw rod 513 to rotate for causing the nut 514 to carry out a linear reciprocal movement, so that the nut 514 drives the Y-axis seat 52 to carry out a Y-axis reciprocal movement to have the tools 553 of the turret unit 50 moved in unison therewith for a Y-axis reciprocal movement.

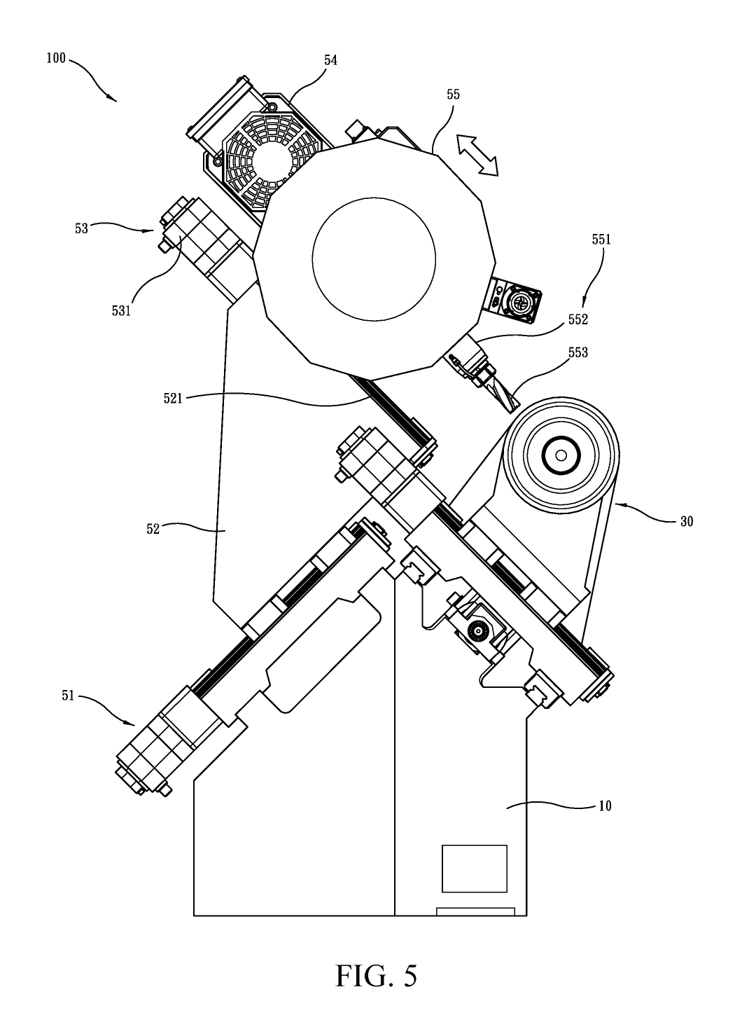

As shown in FIG. 5, in the present invention, the turret unit 50 uses the motor 531 of the X-axis driving source 53 to drive the screw rod 533 to rotate for causing the nut 534 to carry out a linear reciprocal movement, so that the nut 534 drives the X-axis seat 54 to carry out an X-axis reciprocal movement to have the tools 553 of the turret unit 50 moved in unison therewith for an X-axis reciprocal movement. Namely, the tools 553 are controlled to simultaneously carry out the Y-axis reciprocal movement and the X-axis reciprocal movement, or to carry out the Y-axis reciprocal movement or the X-axis reciprocal movement individually.

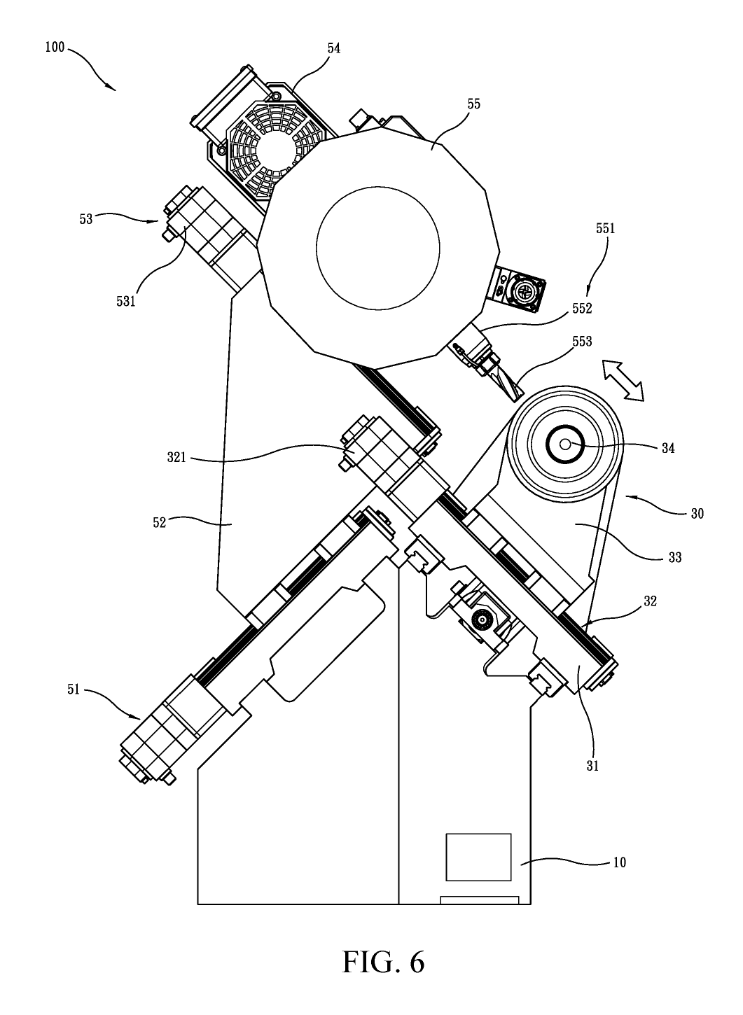

As shown in FIG. 6, in the present invention, the first spindle unit 30 uses the motor 321 of the first compensation power source 32 to drive the screw rod 322 to rotate for causing the nut 324 to carry out a linear reciprocal movement, so that the nut 324 drives the first spindle seat 33 to carry out a reciprocal movement in a compensating axis (wherein the compensating axis is perpendicular to the Z-axis) to have a work piece clamped on the first spindle 33 moved in unison therewith for a reciprocal movement in the compensating axis, where the compensating axis is parallel to the X-axis mounting surface 521.

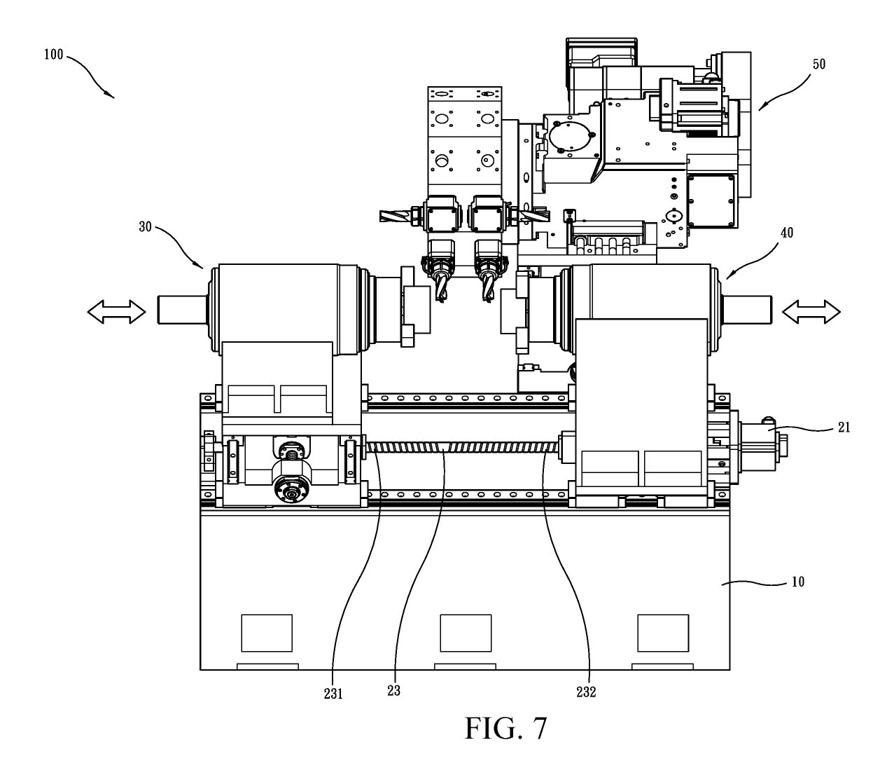

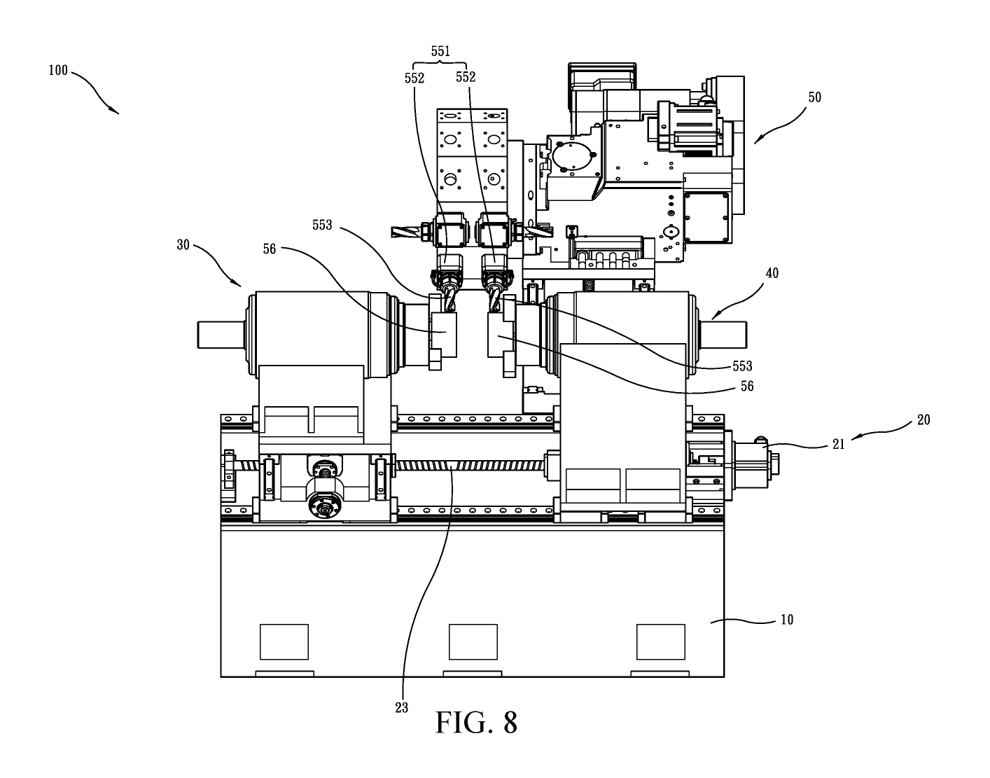

In the present invention, the spindle driving source 20 includes just one single screw rod 23 with a forward thread section 231 and a backward thread section 232 formed on the screw rod 23. The forward thread section 231 and the backward thread section 232 are respectively in mating threading engagement with the first nut 24 and the second nut 25 and the first nut 24 and the second nut 25 are securely fixed with the first spindle unit 30 and the second spindle unit 40, respectively. Thus, as shown in FIGS. 7 and 8, the driving motor 21 of the spindle driving source 20, when put into operation, drives the screw rod 23 to rotate, causing the first nut 24 and the second nut 25 to respectively drive the first spindle unit 30 and the second spindle unit 40, following the screw rod 23, to simultaneously carry out linear reciprocal movements along the same axis (Z-axis) for approaching and moving away. As such, the two tools 553 that are clamped by the clamp group 551 at a specific angle of the turret unit 50 are allowed to simultaneously carry out processing operations on work pieces 56 respectively clamped on the first spindle unit 30 and the second spindle unit 40, thereby providing an effect of doubling the operation efficiency.

Further, in the above embodiment, the Z-axis mounting surface 11, the Y-axis mounting surface 12, and the X-axis mounting surface 521 are all inclined surfaces.

Based on the above, since the present invention needs just one single turret unit to simultaneously carry out processing operations on two work pieces, it is possible to achieve the effect of doubling the processing efficiency, and it is also possible to greatly reduce the overall size and also reduce the fabrication cost thereby improving market competition power.

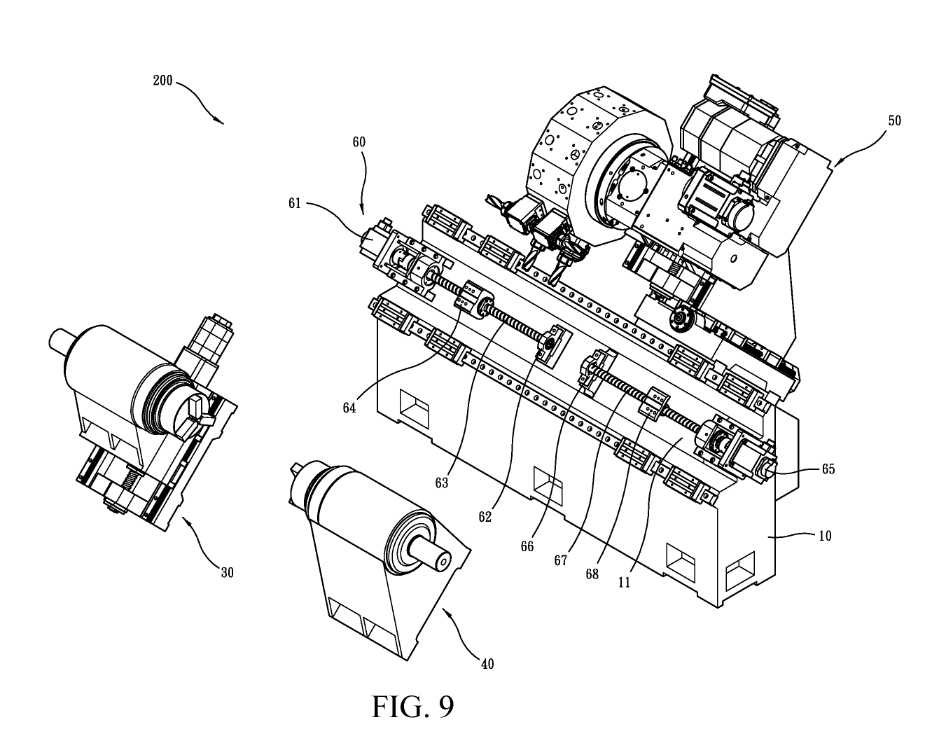

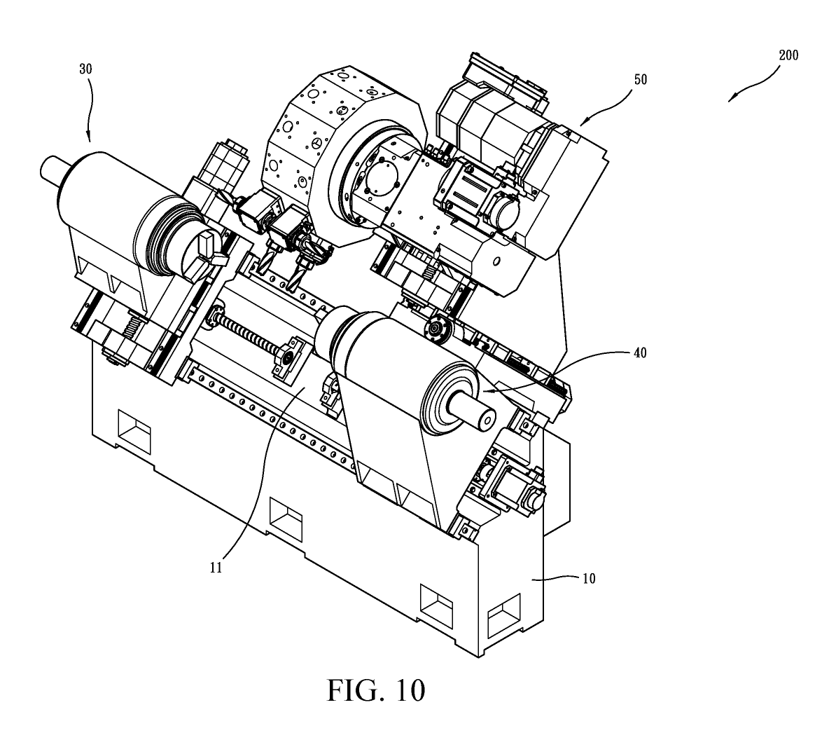

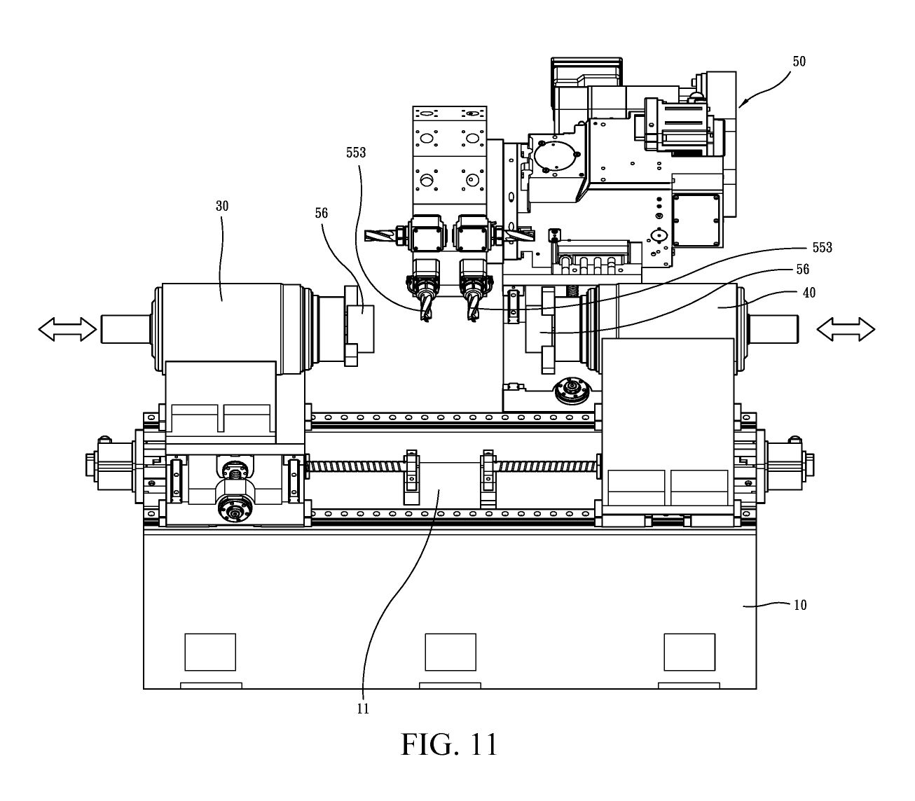

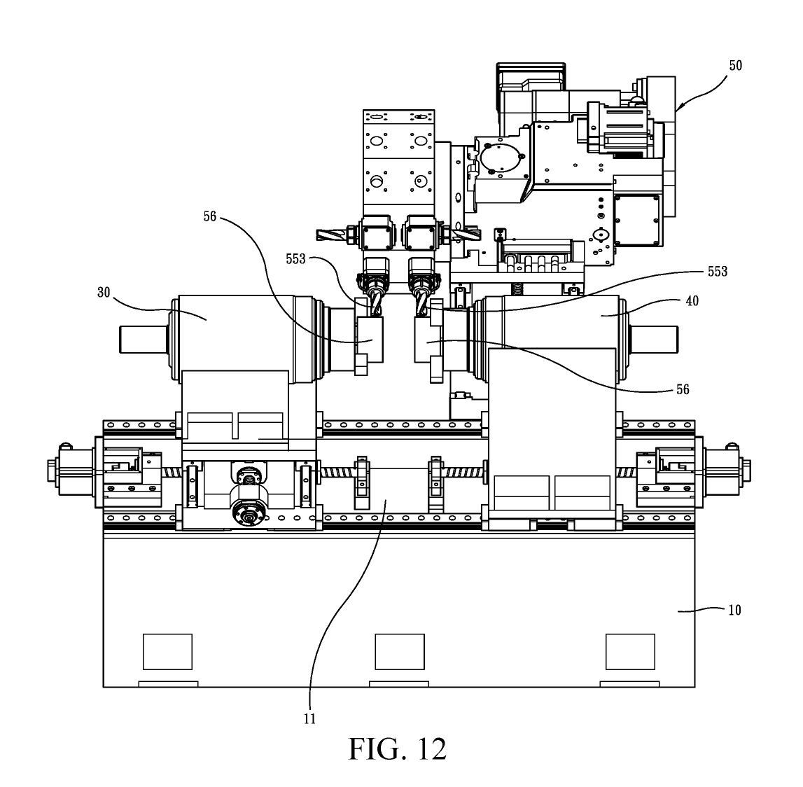

Referring to FIGS. 9-12, the present invention provides, as a second embodiment, a CNC single-turret twin-spindle efficiency-doubled metal processing machine 200, which is substantially the same as the previously described embodiment by comprising a chassis 10, a spindle driving source 60, a first spindle unit 30, a second spindle unit 40, and a turret unit 50. Differences of the instant embodiment from the previous embodiment are as follows:

In the instant embodiment, the spindle driving source 60 comprises a first driving motor 61, a first bearing seat 62, a first screw rod 63, a first nut 64, a second driving motor 65, a second bearing seat 66, a second screw rod 67, and a second nut 68. The first driving motor 61 is mounted on the Z-axis mounting surface 11 of the chassis 10. The first bearing seat 62 is mounted on the Z-axis mounting surface 11 of the chassis 10 at a location close to a middle thereof. The first screw rod 63 has an end coupled to the first driving motor 61 and an opposite end supported by the first bearing seat 62, so that the first screw rod 63 is rotatable, in situ, on the Z-axis mounting surface 11. The first nut 64 is in threading engagement with the first screw rod 63 and the first nut 64 is securely fixed to the first spindle unit 30 to drive the first spindle unit 30 to carry out a linear reciprocal movement along a Z-axis. The second driving motor 65 is mounted on an opposite end portion of the Z-axis mounting surface 11. The second bearing seat 66 is mounted on the Z-axis mounting surface 11 of the chassis 10 at a location close to the middle thereof. The second screw rod 67 has an end coupled to the second driving motor 66 and an opposite end supported by the second bearing seat 66, so that the second screw rod 67 is rotatable, in situ, on the Z-axis mounting surface 11. The second nut 68 is in threading engagement with the second screw rod 67 and the second nut 68 is securely fixed to the second spindle unit 40 to drive the second spindle unit 40 to carry out a linear reciprocal movement along the Z-axis.

In the instant embodiment, the first spindle unit 30 and the second spindle unit 40 are separately driven to move, but with the first driving motor 61 and the second driving motor 65 being put into operation simultaneously, the first spindle unit 30 and the second spindle unit 40 can be simultaneously driven to move along the first screw rod 63 and the second screw rod 67 to both carry out linear reciprocal movements for approaching or moving away on the same axis (the Z-axis), allowing two tools 553 of the turret unit 50 to simultaneously carry out processing operations on two work pieces 56 clamped on the first spindle unit 30 and the second spindle unit 40, respectively.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A computer numerical control CNC single-turret twin-spindle efficiency-doubled metal processing machine, comprising:
a chassis, which comprises a Z-axis mounting surface and a Y-axis mounting surface perpendicular to the Z-axis mounting surface;
a spindle driving source, which is mounted on the Z-axis mounting surface of the chassis;
a first spindle unit, which is arranged on the Z-axis mounting surface of the chassis and coupled to the spindle driving source;
a second spindle unit, which is arranged on the Z-axis mounting surface of the chassis and coupled to the spindle driving source, so that the spindle driving source is operable to simultaneously drive the first spindle unit and the second spindle unit to respectively carry out reciprocal movements on a common axis for approaching and leaving;
a turret unit, which is mounted on the Y-axis mounting surface of the chassis, the turret unit comprising a plurality of clamp groups respectively set at predetermined angles thereon, the clamp group set at each of the predetermined angles comprising two tool clamps, so that the two tool clamps are adapted to clamp and carry two identical tools respectively;
wherein the first spindle unit comprises a first compensation seat, a first compensation power source, a first spindle seat, and a first spindle, the first compensation seat being coupled to the spindle driving source, the first compensation power source being mounted on the first compensation seat, the first compensation power source comprising a motor, a bearing seat, a screw rod, and a nut, wherein the motor is mounted on the first compensation seat; the bearing seat is mounted on an opposite end portion of the first compensation seat; the screw rod has an end coupled to the motor and an opposite end supported by the bearing seat; the nut is in threading engagement with the screw rod; and the first spindle seat is securely fixed to the nut of the first compensation power source and the first spindle is mounted on the first spindle seat and is adapted to clamp a work piece to be processed.

2. The CNC single-turret twin-spindle efficiency-doubled metal processing machine according to claim 1, wherein the spindle driving source comprises a driving motor, a bearing seat, a screw rod, a first nut, and a second nut, the driving motor being mounted on the Z-axis mounting surface of the chassis, the bearing seat being mounted on an opposite end portion of the Z-axis mounting surface of the chassis, the screw rod having an end coupled to the driving motor and an opposite end supported by the bearing seat so that the screw rod is rotatable, in situ, on the Z-axis mounting surface, the screw rod having an outer circumferential surface that comprises a forward thread section and a backward thread section, the first nut being in threading engagement with the forward thread section of the screw rod, the second nut being in threading engagement with the backward thread section, the first spindle unit being securely fixed to the first nut, the second spindle unit being securely fixed to the second nut.

3. The CNC single-turret twin-spindle efficiency-doubled metal processing machine according to claim 1, wherein the spindle driving source comprises a first driving motor, a first bearing seat, a first screw rod, a first nut, a second driving motor, a second bearing seat, a second screw rod, and a second nut, the first driving motor being mounted on the Z-axis mounting surface of the chassis, the first bearing seat being mounted on the Z-axis mounting surface of the chassis at a location adjacent to a middle thereof, the first screw rod having an end coupled to the first driving motor and an opposite end supported by the first bearing seat so that the first screw rod is rotatable, in situ, on the Z-axis mounting surface, the first nut being in threading engagement with the first screw rod, the first nut being securely fixed to the first spindle unit, the second driving motor being mounted on an opposite end portion of the Z-axis mounting surface of the chassis, the second bearing seat being mounted on the Z-axis mounting surface of the chassis at a location adjacent to the middle thereof, the second screw rod having an end coupled to the second driving motor and an opposite end supported by the second bearing seat so that the second screw rod is rotatable, in situ, on the Z-axis mounting surface, the second nut being in threading engagement with the second screw rod, the second nut being securely fixed to the second spindle unit.

4. The CNC single-turret twin-spindle efficiency-doubled metal processing machine according to claim 1, wherein the second spindle unit comprises a second spindle seat and a second spindle, the second spindle seat being coupled to the spindle driving source, the second spindle being mounted on the second spindle seat and adapted to clamp a work piece to be processed.

5. The CNC single-turret twin-spindle efficiency-doubled metal processing machine according to claim 1, wherein the turret unit comprises a Y-axis driving source, a Y-axis seat, an X-axis driving source, an X-axis seat, and a turret, the Y-axis driving source being mounted on the Y-axis mounting surface of the chassis, the Y-axis seat being coupled to the Y-axis driving source so that the Y-axis driving source drives the Y-axis seat to do reciprocal movement along a Y-axis, the Y-axis seat comprising an X-axis mounting surface, the X-axis driving source being mounted on the X-axis mounting surface of the Y-axis seat, the X-axis seat being coupled to the X-axis driving source so that the X-axis driving source drives the X-axis seat to do reciprocal movement along an X-axis, the turret being rotatably mounted on the X-axis seat, the clamp groups being mounted on the turret at the predetermined angles, respectively.

6. The CNC single-turret twin-spindle efficiency-doubled metal processing machine according to claim 5, wherein the Y-axis driving source comprises a motor, a bearing seat, a screw rod, and a nut, the motor being mounted on the Y-axis mounting surface, the bearing seat being mounted on an opposite end portion of the Y-axis mounting surface, the screw rod having an end coupled to the motor and an opposite end supported by the bearing seat, the nut being in threading engagement with the screw rod, the Y-axis seat being securely fixed to the nut of the Y-axis driving source.

7. The CNC single-turret twin-spindle efficiency-doubled metal processing machine according to claim 5, wherein the X-axis driving source comprises a motor, a bearing seat, a screw rod, and a nut, the motor being mounted on the X-axis mounting surface, the bearing seat being mounted on an opposite end portion of the X-axis mounting surface, the screw rod having an end coupled to the motor and an opposite end supported by the bearing seat, the nut being in threading engagement with the screw rod, the X-axis seat being securely fixed to the nut of the X-axis driving source.

8. The CNC single-turret twin-spindle efficiency-doubled metal processing machine according to claim 5, wherein the Z-axis mounting surface, the Y-axis mounting surface, and the X-axis mounting surface are each an inclined surface.

9. A computer numerical control (CNC) single-turret twin-spindle efficiency-doubled metal processing machine, comprising:
a chassis, which comprises a Z-axis mounting surface and a Y-axis mounting surface perpendicular to the Z-axis mounting surface;
a spindle driving source, which is mounted on the Z-axis mounting surface of the chassis;
a first spindle unit, which is arranged on the Z-axis mounting surface of the chassis and coupled to the spindle driving source;
a second spindle unit, which is arranged on the Z-axis mounting surface of the chassis and coupled to the spindle driving source, so that the spindle driving source is operable to simultaneously drive the first spindle unit and the second spindle unit to respectively carry out reciprocal movements on a common axis for approaching and leaving;
a turret unit, which is mounted on the Y-axis mounting surface of the chassis, the turret unit comprising a plurality of clamp groups respectively set at predetermined angles thereon, the clamp group set at each of the predetermined angles comprising two tool clamps, so that the two tool clamps are adapted to clamp and carry two identical tools respectively;
wherein the spindle driving source comprises a first driving motor, a first bearing seat, a first screw rod, a first nut, a second driving motor, a second bearing seat, a second screw rod, and a second nut, the first driving motor being mounted on the Z-axis mounting surface of the chassis, the first bearing seat being mounted on the Z-axis mounting surface of the chassis at a location adjacent to a middle thereof, the first screw rod having an end coupled to the first driving motor and an opposite end supported by the first bearing seat so that the first screw rod is rotatable, in situ, on the Z-axis mounting surface, the first nut being in threading engagement with the first screw rod, the first nut being securely fixed to the first spindle unit, the second driving motor being mounted on an opposite end portion of the Z-axis mounting surface of the chassis, the second bearing seat being mounted on the Z-axis mounting surface of the chassis at a location adjacent to the middle thereof, the second screw rod having an end coupled to the second driving motor and an opposite end supported by the second bearing seat so that the second screw rod is rotatable, in situ, on the Z-axis mounting surface, the second nut being in threading engagement with the second screw rod, the second nut being securely fixed to the second spindle unit.
